(19) United States
(12) Patent Application Publication
(10) Pub. No.: US 2013/0110306 A1
(43) Pub. Date: May 2, 2013

(54) MANAGING MULTIPLE COOLING SYSTEMS IN A FACILITY

(71) Applicants: Zhikui Wang, Fremont, CA (US); Cullen E. Bash, Los Gatos, CA (US); Niru Kumari, Mountain View, CA (US); Amip J. Shah, Santa Clara, CA (US); Tahir Cader, Liberty Lake, WA (US)

(72) Inventors: Zhikui Wang, Fremont, CA (US); Cullen E. Bash, Los Gatos, CA (US); Niru Kumari, Mountain View, CA (US); Amip J. Shah, Santa Clara, CA (US); Tahir Cader, Liberty Lake, WA (US)

(21) Appl. No.: 13/282,390

(22) Filed: Oct. 26, 2011

(51) Int. Cl. G05D 23/00

(52) U.S. Cl. 700/300

(57) ABSTRACT

Systems and methods of managing multiple cooling systems in a facility are disclosed. An example method may include evaluating efficiency of multiple cooling systems for a runtime operating condition. The method may also include selecting an efficient operating configuration of the multiple cooling systems for the runtime operating condition.

### BACKGROUND

Electronics equipment used in data centers generates significant heat during operation. The electronics equipment operates less efficiently at higher temperatures, and may even fail altogether if the temperature in the data center is allowed to rise without implementing some sort of temperature control. Modern data centers typically incorporate at least one, and sometimes many different types of temperature controls to maintain the ambient temperature in a desired range. As data centers continue to increase in size, the electrical power (and other resources such as water) used for cooling can be a significant operating cost.

One way to reduce resource consumption (and associated operating costs) is to design the data center to take advantage of so-called “free” cooling techniques, such as air economizers and water economizers. Another way to reduce resource consumption is to organize the data center, for example, with the electronics equipment grouped together based on cooling demand. These cooling techniques have been utilized in data center environments with different levels of success. However, the cooling capacity of any individual approach is usually limited based on initial design of the data center, and does not account for changes over time.

The cooling capacity of any given approach is dependent to a large extent on variable conditions. For example, the efficiency of both air and water economizers depends largely on the outside temperature, humidity, and even air pollution, which is constantly changing (seasonally, monthly, daily, and even on an hourly basis). The efficiency is also dependent on geographical location, which changes for mobile data centers. For example, cooling that relies on outside air can be used more frequently in the northeast than it can in the southwest portions of the United States.

Data centers may be equipped with cooling systems that can be used when it is not practical to rely on the “free” cooling techniques. For example, mechanical refrigeration systems such as chiller plants and Direct Expansion (DX) units provide cooling capacity that is much less dependent on outside temperature and other conditions than the economizers. But these cooling techniques can be expensive when utilized on a continuous basis.

Active control approaches have also been used to improve efficiency and “fine tune” the cooling delivery/distribution mechanisms for various cooling techniques. For example, control systems may be used to regulate supply/return air for computer room air conditioning (CRAC) units, and by opening and closing vent tiles in front of the equipment racks in a data center. But active controls are dedicated to a particular cooling technique.

### BRIEF DESCRIPTION OF THE DRAWINGS

FIG. 1 is a high-level illustration of an example facility which may implement management of multiple cooling systems.

FIG. 2 is a high level illustration of facility which may implement management of multiple cooling systems.

FIG. 3 is a high-level illustration of an example networked computer system which may be utilized to manage multiple cooling systems.

FIG. 4 shows an example architecture of machine readable instructions, which may be executed to manage multiple cooling systems.

FIGS. 5a-b are flowcharts illustrating example operations for managing multiple cooling systems.

### DETAILED DESCRIPTION

Facilities, such as but not limited to data centers, can be cooled using multiple cooling systems (e.g., on a micro-grid that includes a mix of mechanical cooling, water economizers, and air economizers, among other cooing approaches). Mechanical refrigeration capacity is dependent on external conditions. The primary benefit of mechanical refrigeration is that the range of external conditions acceptable for generation of cooling resources is expanded to higher temperatures. But there may still be a strong functional dependence on outside temperature. As outside temperature increases, mechanical refrigeration capacity either decreases or more work needs to be done (e.g., energy expended) to maintain capacity.

Indeed, each cooling system is attributed with its own operating cost (both resource and economic cost), and cooling capacity, that can vary over time due to a number of factors. The systems and methods described herein consider a multiplicity of factors in determining an efficient operating configuration of the cooling systems. Factors which may be considered include, but are not limited to, ambient air conditions, cost of energy, and maintenance issues. Factors may also incorporate zoning, with each zone cooled by one or more cooling system. For example, the data center may be zoned for processing equipment, data storage equipment, and network communications equipment. Or for example, the data center may be zoned according to usage, with high-use equipment co-located in a separate zone than low-use and/or intermittent-use equipment.

The cooling systems may also introduce dependencies between the factors being considered. Dependencies may be introduced by variable demands on the different types of equipment. For example, utilizing data storage depends at least to some extent on the service being provided, and a processor unit's need for access to data storage. Dependencies may also be introduced by external conditions, such as temperature (which in turn may depend on time of day or other variable).

The efficiencies of various cooling systems may also depend to some extend on the efficiency of individual components in the cooling systems. For example, power consumption by the blowers in an air economizer may be nonlinear depending on one or more parameters (e.g., air flow rate, layout of equipment in the data center). In another example, power consumption by pumps in a water economizer may depend on the flow resistance in the pipe lines used to move the water. In another example, the efficiency of closed-loop cooling through DX units may be dependent on the heat load and efficiency of the cooling units themselves.

While initial selection of cooling systems can be made during the design phase, due to the ongoing variability in operating conditions in a data, the systems and methods described herein may be used to determine efficient configurations of cooling systems during runtime on an ongoing basis. Selection of appropriate cooling system(s) may be based, not only on the heat load and desired cooling effect, but also the relative cost and efficiencies of the availability cooling systems based on analysis of a multiplicity of factors and dependencies.

It is noted that the terms “efficient” and “efficiency” as used herein mean, but are not limited to, resource consumption (e.g., electrical energy, water consumption), output (e.g., heat transfer to the surrounding environment), emissions (e.g., pollution), and financial cost. Efficiency may be established by guidelines, goals or regulations, and/or determined through evaluation of a set of parameterized models.

It is also noted that as used herein, the terms “includes” and “including” mean, but is not limited to, “includes” or “including” and “includes at least” or “including at least.” The term “based on” means “based on” and “based at least in part on.”

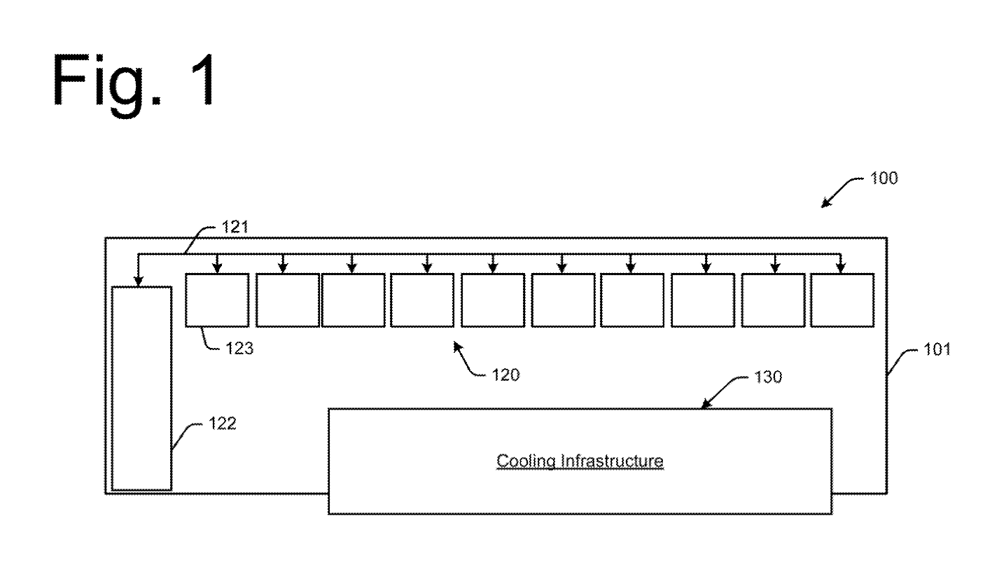

FIG. 1 is a high-level illustration of an example facility such as a data center 100 which may implement management of multiple cooling systems. Modern data centers offer a consolidated environment 101 for providing, maintaining, and upgrading hardware and software for an enterprise, in addition to more convenient remote access and collaboration by many users. However, it is noted that the systems and methods described herein may be utilized with respect to an individual data center and/or multiple data centers (e.g., geographically distributed data centers belonging to or managed by an enterprise). It is noted that while the examples are described herein with reference to data center, the systems and methods may be implemented with any facility, such as an office building, manufacturing plant, or other facility.

Modern data centers provide more efficient delivery of computing services. For example, it is common for the processor and data storage for a typical desktop computer to sit idle over 90% of the time during use. This is because the most commonly used applications (e.g., word processing, spreadsheets, and Internet browsers) do not require many resources. By consolidating processing and data storage in a data center, the same processor can be used to provide services to multiple users at the same time.

Data centers can include many different types of computing resources, including processing capability, storage capacity, and communications networks, just to name a few examples of equipment and infrastructure. The number and type of computing resources provided by a data center may depend at least to some extent on the type of customer, number of customers being served, and the customer requirements. Data centers may be any size. For example, data centers may serve an enterprise, the users of multiple organizations, multiple individual entities, or a combination thereof.

Regardless of the physical configuration and location of the data center 100, communications in data centers are typically network-based. The most common communications protocol is the Internet protocol (IP), however, other network communications may also be used. Network communications may be used to make connections with internal and/or external networks. Accordingly, the data center 100 may be connected by routers and switches and/or other network equipment 121 that move network traffic between the servers and/or other computing equipment 122, data storage equipment 123, and/or other electronic devices and equipment in the data center 100 (referred to herein generally as the “IT infrastructure” 120).

Operating the infrastructure results in heat generation. Accordingly, the data center 100 may also include various environmental controls, such as equipment used for cooling operations in the data center. The cooling equipment is referred to herein generally as the “cooling infrastructure” 130.

The cooling infrastructure may include multiple cooling systems, such as relatively inexpensive air movers (e.g., fans and blowers) that utilize outside or ambient air for cooling operations, and water economizers that utilize an available water source, and therefore are less resource-intensive. Cooling systems may also be more expensive refrigeration, air conditioning, evaporative cooling, and condensed cooling techniques, to name only a few examples of more resource-intensive cooling.

The type of cooling systems and configuration of the cooling infrastructure 130 may depend to some extent on the type and configuration of the IT infrastructure 120 at the data center. The cooling infrastructure 130 may also depend to some extent on the workload (e.g., use of the IT infrastructure 120), and external conditions (e.g., the outside air temperature). In an example, the cooling infrastructure 130 may be configured and/or reconfigured to provide an efficient utilization of the cooling infrastructure 130 at the data center 100.

It is noted that the data center 100 is not limited to use with any particular type, number, or configuration of cooling infrastructure 130. The data center 100 shown in FIG. 1 is provided as an illustration of an example operational environment, but is not intended to be limiting in any manner.

The main purpose of the data center 100 is providing customers (e.g., service providers), and turn the end-users with access to computing resources, including but not limited to data processing resources, data storage, and/or application handling. A customer may include anybody (or any entity) who desires access to resource(s) in the data center 100. The customer may also include anybody who desires access to a service provided via the data center 100. Providing the client access to the resources in the data center 100 may also include provisioning of the resources, e.g., via file servers, application servers, and the associated middleware.

During use, customers and end-users (referred to generally herein as “users”) may desire access to the data center 100 for a particular purpose. Example purposes include executing software and providing services which were previously the exclusive domain of desktop computing systems, such as application engines (e.g., word processing and graphics applications), and hosted business services (e.g., package delivery and tracking, online payment systems, and online retailers), which can now be provided on a broader basis as hosted services via data center(s).

Use of the data center 100 by customers may be long term, such as installing and executing a database application, or backing up data for an enterprise. The purpose may also be short term, such as a large-scale computation for a one-time data analysis project.

The data center 100 is typically managed by an operator. An operator may include anybody (or any entity) who desires to manage the data center 100. For purposes of illustration, an operator may be a network administrator. The network administrator in charge of managing resources for the data center 100, for example, to identify suitable resources in the data center 100 for deploying a service on behalf of a customer. In another example, the operator may be an engineer in charge of managing the data center 100 for an enterprise. The engineer may deploy and manage processing and data storage resources in the data center 100. The engineer may also be in charge of accessing reserved resources in the data center 100 on an as-needed basis. The function of the operator may be partially or fully automated, and is not limited to network administrators or engineers.

The systems and methods described herein may implement techniques to management multiple cooling systems (i.e., the cooling infrastructure 130) for the data center 130. Output from these systems and methods may be deployed manually (e.g., by the operator), automatically (e.g., using control systems), and/or via a combination of manual and automatic techniques, to realize efficiencies and associated power savings at the data center 100.

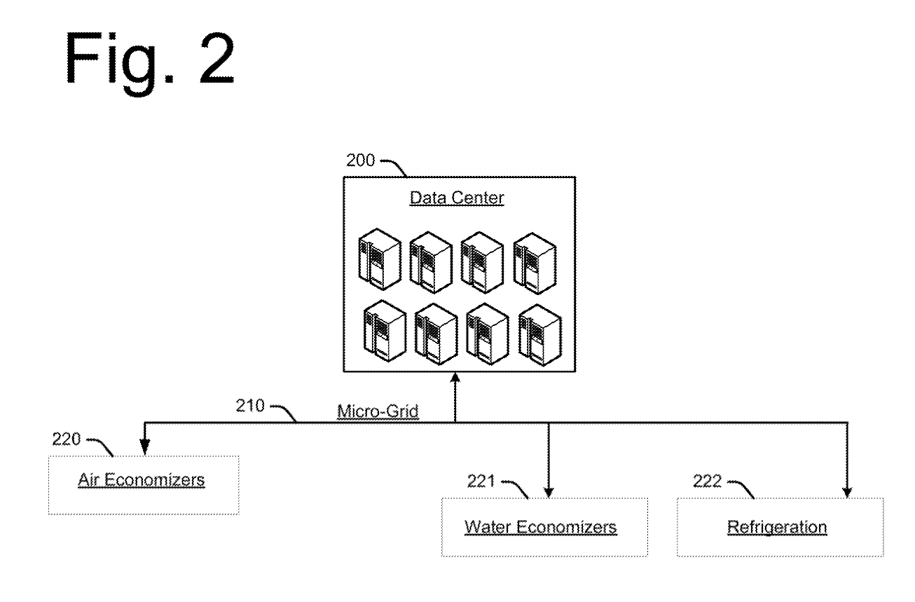

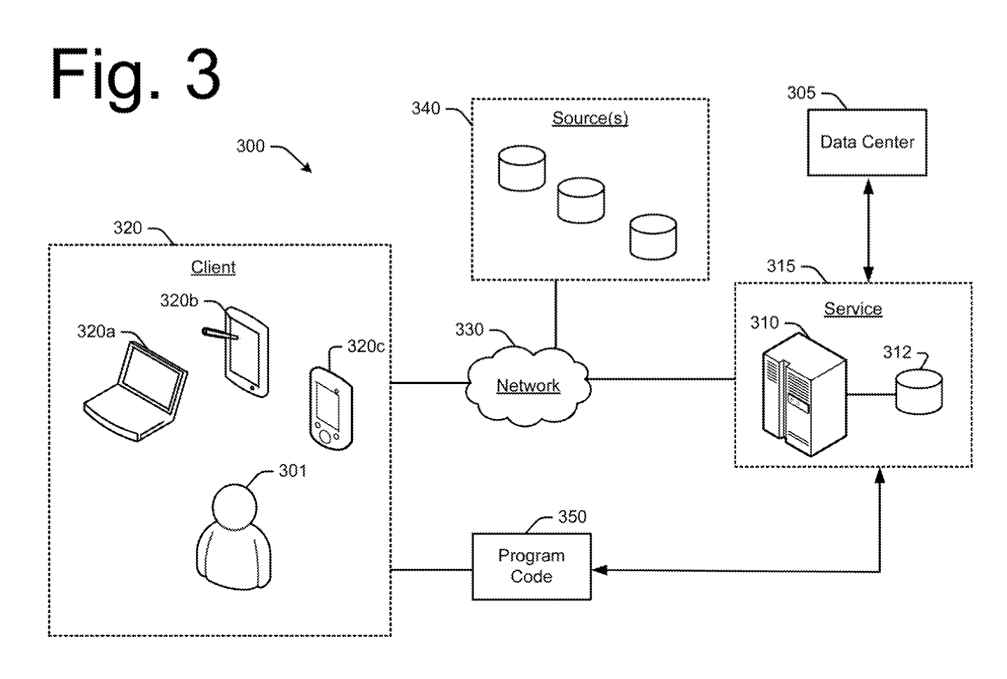

FIG. 2 is a high level illustration of a facility such as a data center 200 which may implement management of multiple cooling systems. The data center 200 may include a micro-grid 210 connecting any number of different cooling systems. In the example shown in FIG. 2, micro-grid 210 may connect cooling systems such as air economizers 220, water economizers 221, and refrigeration 223, to name only a few examples. The micro-grid 210 is not limited to use with these cooling systems, and may also be utilized with other cooing systems now known and later developed.

The data center 200 may achieve efficient cooling operations using any of a number of different techniques. The micro-grid 210 and/or cooling systems 220-222 on the micro-grid 210 may be modeled to consider a number of different factors and dependencies for operating the cooling infrastructure. Factors have been described above, and may further include the physics of particular cooling system(s) and/or the data center itself. For example, a vapor compressor may include multiple components, such as the compressor, pump, and fans. The performance (and efficiency) of the cooling system as a whole (i.e., the vapor compressor in this example) may depend at least to some extent on how the air is moved by the vapor compressor.

The cost and efficiency of the cooling systems can be modeled quantitatively as a function of external conditions and the heat load. These models may be abstracted, based on reference models, physical models, or empirical (in-situ) models. The efficiency and cooling capacity can then be quantified based on the factors identified above, runtime conditions of the data center (e.g., the operation envelope), and the cooling system(s) (e.g., maximum blower speed and flow resistance). Quantized output from the model can then be used for the operational control and management of the cooling grid 210.

The efficiency and capacity functions may be re-evaluated dynamically, or in real-time, based on variable factors such as the actual heat load, external conditions and other parameters that are being monitored. The output may also be used to define a threshold whereupon the cooling approach is switched.

These and other examples are contemplated for realizing efficient cooling at the data center 200. Further operations for managing the cooling systems in the data center 200 will now be explained with reference to FIG. 3.

FIG. 3 is a high-level illustration of an example networked computer system 300 which may be utilized by an operator for managing multiple cooling systems in a data center 305 (e.g., the cooling systems and data center shown in FIGS. 1 and 2). System 300 may be implemented with any of a wide variety of computing devices for monitoring equipment use, and responding to dynamic cooling demands of the data center by configuring use of cooling system(s) in an efficient manner.

Example computing devices include but are not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the system 300 may include a host 310 providing a service 315 accessed by an operator 301 via a client device 320. For purposes of illustration, the service 315 may be implemented as a data processing service executing on a host 310 configured as a server computer with computer-readable storage 312. The service 315 may include application programming interfaces (APIs) and related support infrastructure. The service 315 may be accessed by the operator to manage workload at the data center 305. The operator 301 may access the service 315 via a client 320. The client 320 may be any suitable computer or computing device 320a-c capable of accessing the host 310.

Host 310 and client 320 are not limited to any particular type of devices. Although, it is noted that the operations described herein may be executed by program code residing entirely on the client (e.g., personal computer 320a), in other examples (e.g., where the client is a tablet 320b or other mobile device 320c) the operations may be better performed on a separate computer system having more processing capability, such as a server computer or plurality of server computers (e.g., the host 310) and only accessed by the client 320.

In this regard, the system 300 may include a communication network 330, such as a local area network (LAN) and/or wide area network (WAN). The host 310 and client 320 may be provided on the network 330 via a communication protocol, such as via an Internet service provider (ISP). Such a configuration enables the client 320 to access host 310 directly via the network 330, or via an agent, such as another network (e.g., in remotely controlled applications). In an example, the network 330 includes the Internet or other mobile communications network (e.g., a 3G or 4G mobile device network). Network 330 may also provide greater accessibility to the service 315 for use in distributed environments, for example, where more than one operator may have input and/or receive output from the service 315.

The service 315 may be implemented in part via program code 350. In an example, the program code 350 is executed on the host 310 for access by the client 320. For example, the program code may be executed on at least one computing device local to the client 320, but the operator is able to interact with the service 315 to send/receive inputioutput (I/O) in order to manage cooling systems in the data center 305.

Before continuing, it is noted that the computing devices described above are not limited in function. The computing devices may also provide other services in the system 300. For example, host 310 may also provide transaction processing services and email services and alerts or other notifications for the operator via the client 320.

During operation, the service 315 may be provided with access to local and/or remote source(s) 340 of information. The information may include information for the data center 305, equipment configuration(s), power requirements, and cooling mechanisms. Information may also include current workload and opportunities to realize savings by managing the cooling systems. The information may originate in any manner, including but not limited to, historic data and real-time monitoring.

The source 340 may be part of the service 315, and/or the source may be physically distributed in the network and operatively associated with the service 315. In any implementation, the source 315 may include databases for providing the information, applications for analyzing data and generating the information, and storage resources for maintaining the information. There is no limit to the type or amount of information that may be provided by the source. In addition, the information provided by the source 340 may include unprocessed or “raw” data, or data may undergo at least some level of processing before being provided to the service 315 as the information.

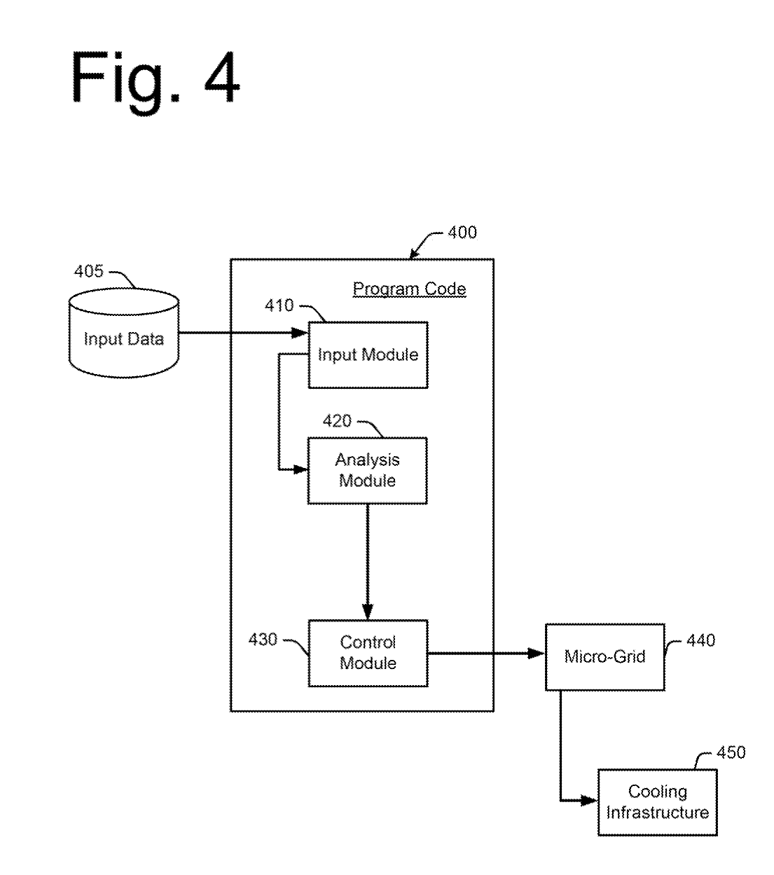

As mentioned above, operations for managing cooling systems in the data center may be embodied at least in part in executable program code 350. The program code 350 used to implement features of the systems and methods described herein can be better understood with reference to FIG. 4 and the following discussion of various example functions. However, the operations are not limited to any specific implementation with any particular type of program code.

FIG. 4 shows an example architecture 400 of machine readable instructions, which may be executed for managing cooling systems at a data center. The program code may be implemented in machine-readable instructions (such as but not limited to, software or firmware). The machine-readable instructions may be stored on a non-transitory computer readable medium and are executable by one or more processor to perform the operations described herein. It is noted, however, that the components shown in FIG. 4 are provided only for purposes of illustration of an example operating environment, and are not intended to limit implementation to any particular system.

The program code may execute the function of the architecture of machine readable instructions as self-contained modules. These modules can be integrated within a self-standing tool, or may be implemented as agents that run on top of an existing program code. In an example, the architecture of machine readable instructions may include an input module to receive input data 405, and an analysis module 420.

In an example, the analysis module 420 analyzes real-time operating parameters of the data center infrastructure, including but not limited to heat load. Example usage information may include resources being used in the data center and corresponding cooling requirements. The information may also include alternative configurations of the cooling infrastructure, such as use allocations and interoperability between components, which may be used to analyze dependencies impacting efficiency of the cooling operations at the data center.

Analysis may include dynamic trade-offs between the efficiencies of adding or removing cooling systems. The analysis may be at any level of granularity. For example, the analysis module 420 may analyze information for specific equipment. In another example, the analysis module 420 may analyze information classes of devices. The analysis module 420 may take into consideration factors such as availability, and in addition, specific characteristics of the resources.

During operation, the analysis module 420 may map cooling infrastructure to cooling demand by equipment use (and associated heat load) in the data center. Cooling systems can be managed via a control module 430 operatively associated with a micro-grid 440 and/or the cooling infrastructure 450 for the data center.

Before continuing, it should be noted that the examples described above are provided for purposes of illustration, and are not intended to be limiting. Other devices and/or device configurations may be utilized to carry out the operations described herein.

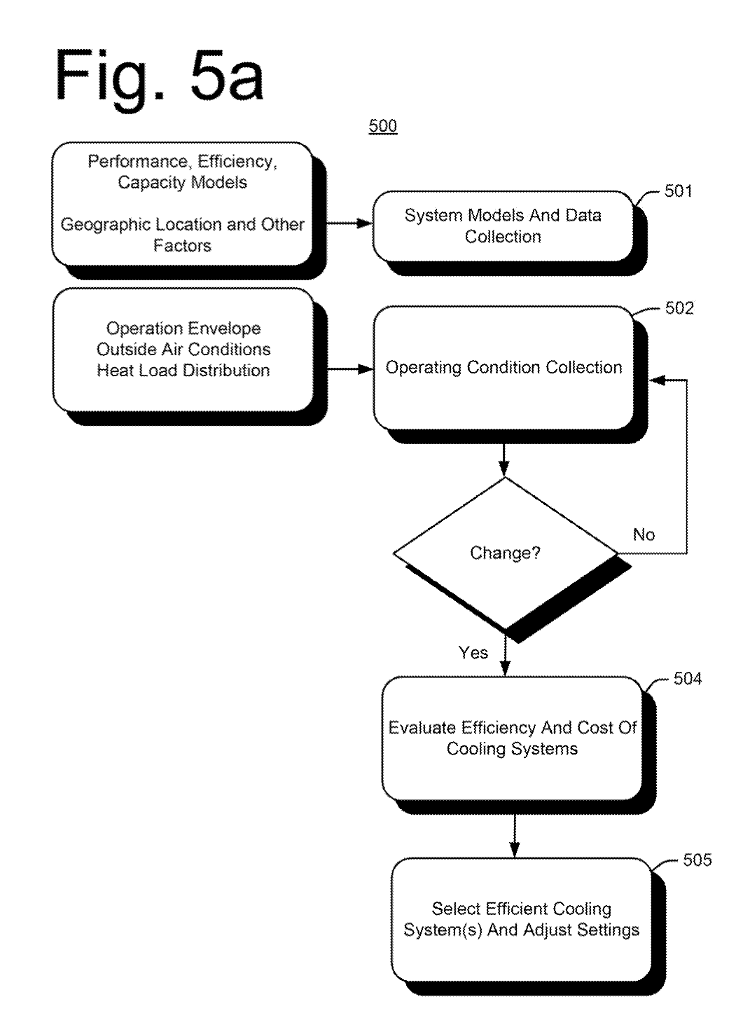

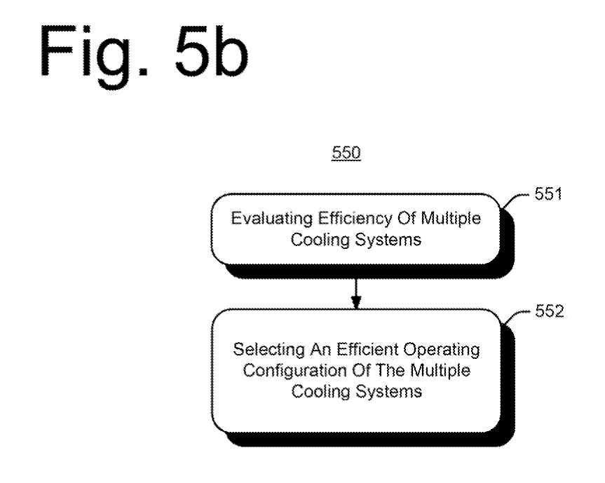

FIGS. 5a-b are flowcharts illustrating example operations for managing multiple cooling systems in a data center. Operations 500 and 550 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

In FIG. 5a, operation 501 includes collecting data on cooling systems, including modeling performance, efficiency, capacity, and cost. For example, fan curves, heat exchanger efficiency, and chiller efficiency, all may be parameterized using the variables that represent the operation conditions of the facility such as a data center.

Operation 502 includes collecting operation conditions. Examples of these conditions may include, but are not limited to, outside air conditions (such as temperature and humidity based on geographical location and time), heat load in the facility and its spatial distribution, thermal limits and operation envelopes of the IT equipment in the facility.

Operation 503 includes monitoring operating conditions on a continuous basis. If the changes are significant (e.g., exceed an efficiency threshold), then operations proceed to 504. Otherwise, the operations may repeat.

Operation 504 includes evaluating the efficiency of all cooling systems for the operating conditions and heat loads. An optimization algorithm may be used to determine an optimal combination of the cooling systems to provide the needed cooling capacity at a minimum cost.

Operation 505 includes outputting results from the model. Output may be to the cooling system controller(s), for example, to automatically adjust the cooling system set points. Output may also be to an advisory system, which the operator can then use to manually adjust the cooling system set points.

In FIG. 5b, operation 551 includes evaluating efficiency of multiple cooling systems for a runtime operating condition. Operation 552 includes selecting an efficient operating configuration of the multiple cooling systems for the runtime operating condition. In an example, operations may automatically reconfigure the cooling systems to achieve the efficient operating configuration for a current runtime operating condition.

The operations shown and described herein are provided to illustrate example implementations. It is noted that the operations are not limited to the ordering shown. Still other operations may also be implemented.

Further operations may include responding to a change in the runtime operating condition by selecting a different efficient operating configuration of the multiple cooling systems. Operations may also include outputting the efficient operating configuration to an operator via an advisory system.

Further operations may also include modeling the runtime operating condition. The model may utilize information for the multiple cooling systems including at least performance, efficiency, and cooling capacity. The model may also utilize information for facility conditions including at least ambient temperature, humidity, and pollution. The model may also utilize information for equipment in the facility including at least equipment configuration, workload, and operational zoning. The model may also utilize information for outside air conditions and heat load distribution.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method of managing multiple cooling systems in a facility, the method comprising:
evaluating efficiency of multiple cooling systems for a runtime operating condition; and
selecting an efficient operating configuration of the multiple cooling systems for the runtime operating condition.

2. The method of claim 1, further comprising monitoring a plurality of factors for the runtime operating condition.

3. The method of claim 2, further comprising responding to a change in the runtime operating condition by selecting a different efficient operating configuration of the multiple cooling systems.

4. The method of claim 1, further comprising outputting the efficient operating configuration to an operator via an advisory system.

5. The method of claim 1, further comprising modeling the runtime operating condition.

6. The method of claim 5, further comprising feeding the model information for the multiple cooling systems including at least performance, efficiency, and cooling capacity.

7. The method of claim 5, further comprising feeding the model information for facility conditions including at least ambient temperature, humidity, and pollution.

8. The method of claim 5, further comprising feeding the model information for equipment in the facility including at least equipment configuration, workload, and operational zoning.

9. The method of claim 5, further comprising feeding the model information on at least one of outside air conditions and heat load distribution.

10. The method of claim 1, further comprising automatically reconfiguring the cooling systems to achieve the efficient operating configuration for a current runtime operating condition.

11. A system for managing multiple cooling systems in a facility, the system including machine readable instructions stored in a non-transitory computer-readable medium, the machine readable instructions comprising instructions executable to cause a processor to:
evaluating efficiency of multiple cooling systems for a runtime operating condition; and
selecting an efficient operating configuration of the multiple cooling systems for the runtime operating condition.

12. The system of claim 11, wherein the machine readable instructions further comprise instructions executable to cause the processor to monitor a plurality of factors for the runtime operating condition.

13. The system of claim 11, wherein the machine readable instructions further comprise instructions executable to cause the processor to select a different efficient operating configuration of the multiple cooling systems.

14. The method of claim 11, wherein the machine readable instructions further comprise instructions executable to cause the processor to optimize a micro-grid for the multiple cooling systems based on offline models and online calibration.

15. The system of claim 11, wherein the machine readable instructions further comprise instructions executable to cause the processor to model the runtime operating condition based on monitored input at the facility in real-time.

16. The system of claim 11, wherein the machine readable instructions further comprise instructions executable to cause the processor to analyze information for the multiple cooling systems including at least performance, efficiency, and cooling capacity.

17. The system of claim 11, wherein the machine readable instructions further comprise instructions executable to cause the processor to analyze information for facility conditions including at least ambient temperature, humidity, and pollution.

18. The system of claim 11, wherein the machine readable instructions further comprise instructions executable to cause the processor to analyze information for equipment in the facility including at least equipment configuration, workload, and operational zoning.

19. The system of claim 11, wherein the machine readable instructions further comprise instructions executable to cause the processor to analyze information on outside air conditions and heat load distribution.

20. The system of claim 11, wherein the machine readable instructions further comprise instructions executable to cause the processor to analyze reconfigure the cooling systems to achieve the efficient operating configuration for a current runtime operating condition.
